(19) United States
(12) Patent Application Publication
(10) Pub. No.: US 2019/0072210 A1
(43) Pub. Date: Mar. 7, 2019

(54) Position Indicator as Well as a Rotary Actuator Equipped Therewith and a Process Valve

(71) Applicant: FESTO AG & Co. KG, Esslingen (DE)

(72) Inventors: Andreas Feiler, Schwabisch Gmund (DE); Tobias Mozer, Wendlingen (DE); Mathias Schneider, Stuttgart (DE)

(21) Appl. No.: 16/122,110

(22) Filed: Sep. 5, 2018

(30) Foreign Application Priority Data
Sep. 6, 2017 (DE) 102017215656.2

(51) Int. Cl. F16K 37/00

(52) U.S. Cl. CPC F16K 37/0008; F16K 37/0058

(57) ABSTRACT

A position indicator for a rotary drive of a process valve is proposed, which can be mounted on a rotatable indicator shaft of the rotary drive and which has a base indicator element and an additional indicator element, wherein the additional indicator element can be positioned and fixed about a vertical axis in different angular positions. On the base indicator element a plurality of base indicator markings are arranged, while the additional indicator element has an additional indicator markings. In order to indicator various visually perceptible valve-type symbols, the additional indicator element can be positioned, inter alia, in at least one cover angle position, in which it covers at least one base indicator marking, but leaves at least one further base indicator marking uncovered, which together with the always visible additional indicator marking represents the valve-type symbol.

### BACKGROUND OF THE INVENTION

The invention relates to a position indicator for a rotary drive of a process valve, which is designed for the torque-proof mounting on a rotatable indicator shaft of the rotary drive and has a vertical axis that in the mounted position of use coincides with the axis of rotation of the indicator shaft, with a base indicator element having at least one base indicator marking and an additional indicator element having an additional indicator marking, wherein the additional indicator element can be positioned and fixed about the vertical axis as centre in different rotational angular positions with respect to the base indicator element.

The invention further relates to a rotary drive of a process valve, with a drive housing in which are arranged drive means for generating a rotary drive movement of a drive shaft that can be coupled or is coupled to the rotatable valve member of a valve fitting and is accessible on its outer side of the end portion of a rotatable indicator shaft rotating together with the drive shaft, on which is mounted a position indicator participating in the rotational movement of the indicator shaft.

The invention also relates to a process valve with a valve fitting and a rotary drive fastened to the valve fitting for rotationally driving a valve member of the valve fitting, wherein the rotary drive has a rotatable indicator shaft on which a position indicator is mounted.

From U.S. Pat. No. 6,135,147 a rotary drive used in connection with a process valve is known, which is provided with a position indicator mounted on a rotatable indicator shaft, by means of which the open position and the closed position of the process valve is visually recognisable. The position indicator has two indicator elements, each having an indicator marking configured in the manner of a pointer and which are rotatable with respect to one another about a vertical axis of the position indicator, in order to be able to adjust different angular positions between the two indicator markings. Each indicator element is additionally equipped with a permanent magnet in order additionally to be able to perform a position detection that can be used for the operation of the rotary drive.

U.S. Pat. No. 6,820,647 B1 discloses a position indicator for a valve, which is rotated when the valve is actuated and is provided with visually recognisable markings, which are visible depending on the rotational position through a viewing window of a stationary housing.

From WO 2016/202355 A1 a rotary drive is known for actuating a process valve and which has drive means arranged in a drive housing, by means of which an indicator shaft is driven, which is equipped in a torque-proof manner with a position indicator. The position indicator is designed as a magnetic module cooperating with a sensor module and also has a bow-shaped indicator marking, which symbolises the valve-type of the process valve and visually indicates the current position of a valve member of the process valve.

### SUMMARY OF THE INVENTION

The object of the invention is to adopt measures that promote a simple and clear visual position indication in process valves of different valve-types.

To achieve this object, in conjunction with a position indicator of the type mentioned in the introduction it is envisaged that the base indicator element has a plurality of base indicator markings arranged distributed around the vertical axis, wherein the additional indicator element can be positioned and fixed in at least one cover angle position with respect to the base indicator element, in which it covers at least one of the base indicator markings and in which at least one of the base indicator markings is uncovered, so that, depending on the angular position adopted by the additional indicator element different visually perceptible valve-type symbols can be represented, which in each case are composed of the additional indicator marking and the at least one uncovered base indicator marking.

The object is furthermore achieved with a rotary drive of the type mentioned in the introduction, in that it has a position indicator designed in the aforementioned sense.

Furthermore, the object is achieved in conjunction with a process valve of the type mentioned in the introduction in that the position indicator and/or the rotary drive is formed in the aforementioned sense.

In this way one and the same position indicator can be used in connection with different types of process valves for the unambiguous visualisation of the individual operating positions. In its mounted position of use the position indicator is fixed in a torque-proof manner to a rotatable indicator shaft of a rotary drive serving to actuate a process valve, so that it participates in the rotational movement of the indicator shaft and provides an optical feedback on the current position of the rotary drive and thus indirectly also on the position of a valve member of a valve fitting mounted on the rotary valve. At least two indicator markings arranged distributed around the vertical axis are provided on the base indicator element, which are referred to as base indicator markings for the sake of a better differentiation and which likewise participate in the rotational movement of the position indicator as a further indicator marking, termed additional indicator marking, which is arranged on the additional indicator marking, which is fixed in a selected angular position with respect to the base indicator element. The additional indicator element is designed as a cover element, which can be attached in at least one angular position with respect to the base indicator element, which is referred to as cover angle position, because at least one of the base indicator markings is covered by the correspondingly positioned additional indicator element, while at the same time at least one base indicator marking is not covered. Accordingly, depending on the adjusted angular position of the additional indicator element different valve-type symbols can be represented by the visible indicator markings, which symbolise the valve-type of the associated process valve. With the aid of the indicator markings forming the represented valve-type symbol the operating position of the respectively adjusted process valve can also be read off very easily and specific to the valve-type.

Advantageous developments of the invention will become apparent from the dependent claims.

The base indicator element expediently has two, and in particular exactly two, base indicator markings angularly offset by 90 degrees with respect to one another, which can be selectively covered by the additional indicator element or both can be left uncovered. The additional indicator element may conveniently as an alternative be positioned in one of two cover angle positions, in which it respectively covers one of the two base indicator markings, so that the respectively uncovered base indicator marking together with the always visible additional indicator marking represents one of several different valve-type symbols. A further valve-type symbol can be represented by the fact that the additional indicator being can be positioned in an angular position leaving the two base indicator markings uncovered, with the result that a valve-type symbol is obtained consisting of two visible base indicator markings and the additional indicator marking.

Depending on the valve-type symbols to be represented, the base indicator element can readily also have more than two base indicator markings arranged angularly offset relative one another. In this case, in particular also the angular ranges between base indicator markings arranged adjacent to one another in the circumferential direction of the vertical axis can be predetermined as required.

A position indicator in which the additional indicator element can be positioned and fixed in three angular positions with respect to the base indicator element is regarded as particularly convenient, in which the additional indicator marking in each case together with at least one in each case uncovered base marking represents an I-shaped or L-shaped or T-shaped valve-type symbol. A valve-type with rectilinear fluid passage in the open position can be symbolised by the I-shaped valve-type symbol. With an L-shaped valve-type symbol a valve-type can be indicated that has a right-angled flow path depending on the adjusted operating position. With a T-shaped valve-type symbol a process valve can be symbolised, with which a flow branching or fluid mixing can be performed. Typically an “I” type process valve has two rectilinear valve connections, while a “L” type process valve has three valve connections and a “T” type process valve has four valve connections.

Each indicator marking is expediently designed in the form of a strip with a radial alignment with respect to the vertical axis of the position indicator. The valve-type symbols can thus be seen very clearly. The indicator markings are printed for example in a selected colour, or in the case of a two-component injection moulding method are integrated directly with a differently coloured plastic in an indicator element consisting of plastic material.

Alternatively, each indicator marking may be composed of a plurality of marking portions spaced apart in a row.

Preferably the base indicator element is that indicator element that is responsible for a non-rotatable positive engagement fixing of the position indicator with respect to the indicator shaft in the mounted position of use. The base indicator element has on a lower side preferably a mounting interface coaxial with the vertical axis for the torque-free plug-in connection with an end portion of the indicator shaft of the rotary drive.

For the fixing to the indicator shaft of the rotary drive and expediently for the simultaneous mutual bracing of the two indicator elements, the position indicator preferably has a fastening screw, which passes through the two indicator elements in the axial direction of the vertical axis and is screwed to the indicator shaft.

Instead of the fastening screw, a fastening clip latchingly engaged with the indicator shaft can for example also be provided.

In a preferred configuration of the position indicator, the base indicator element is disc-shaped and has a circular outer contour when viewed in the axial direction of the main axis. In the position of use mounted on the indicator shaft, an upper end face of the base indicator element faces away from the rotary drive, while an outer circumferential surface extending around the vertical axis faces radially outwards. The additional indicator element is formed L-shaped and has two first and second leg sections arranged angularly with respect to one another. In the state of the additional indicator element attached to the base indicator element, the first leg section at least partially having the additional indicator marking extends along the upper end face of the base indicator element in a radial direction with respect to the vertical axis, while the second leg section adjoining this particularly in one piece projects downwardly in the direction of the rotary drive and thereby extends in the axial direction, i.e. in the axial direction of the vertical axis along the outer circumferential surface of the base indicator element. The additional indicator marking may be partially located on the first leg section and partially on the second leg section. It can accordingly have an angled longitudinal position.

The base indicator element is expediently formed dish-shaped and is open on its underneath side, and can be mounted or is mounted with the open underneath side in front on the indicator shaft.

The handling and visualisation is favoured if the outer circumferential surface of the base indicator member tapers axially in the direction of the upper end face, the second leg section of the additional indicator member being correspondingly inclined. In this way a certain centring effect can also be achieved when the additional indicator element is attached to the base indicator element.

The first leg section of the additional indicator element extending along the upper end face of the base indicator element is conveniently formed in the shape of a circular sector. In particular, in connection with the provision of the base indicator element with two base indicator markings offset by 90 degrees with respect to one another, it is advantageous if the central angle of the first leg section of the additional indicator element formed as a circular sector is 90 degrees. The second leg section adjoining the first circular sector-shaped leg section second leg section is preferably shell-shaped and has a curvature adapted to the outer circumferential surface of the base indicator element. As a result, in the state of the additional indicator element when fixed to the base indicator element, both leg sections can rest on a large area on the outer surface of the base indicator element.

Preferably, the additional indicator marking is located in the region of one of the two side edges of the first leg section oriented in the circumferential direction of the vertical axis and is arranged in particular on the outer surface of the first leg section facing away from the base indicator element, so that it is very easily visible to the viewer.

For ease of assembly the first leg section of the additional indicator element on its free end region facing away from the second leg section is expediently penetrated by a fastening hole provided for the engagement of the above-mentioned fastening screw, the said fastening hole being aligned with a further fastening hole passing centrally axially through the base indicator element. For fastening in the use position, a fastening screw can be passed through the two fastening holes, which is screwed into a front-side threaded bore of the end portion of the rotatable indicator shaft and is supported by a screw head on the upper side of the additional indicator element facing away from the additional indicator element, and thereby the two indicator elements are clamped jointly with the indicator shaft in the axial direction of the vertical axis.

In principle, a sufficient axial bracing between the two indicator elements is already sufficient to fix the adjusted angular position purely by frictional engagement. In order to obtain a particularly high level of security against accidental alteration of the adjusted setting, it is however advantageous if a toothed device is associated jointly with the two indicator elements, by means of which the additional indicator element in the respectively adjusted angular position is locked in a torque-proof manner on the base indicator element.

With the help of such a toothed device, which may in principle be formed in an arbitrary manner, it is therefore possible in particular to fix the additional indicator element in a torque-proof manner in a gradation predetermined by the tooth pitch of the toothed device in a variable angular rotational manner with respect to the base indicator element. An embodiment of the toothed device that allows an angular positioning of the additional indicator element in 5-degree increments is found to be especially advantageous.

The toothed device is in particular designed so that the additional indicator element can by releasing the positive toothed engagement be lifted axially away from the base indicator element to change its angular position adopted with respect to the base indicator element, can then be rotated with respect to the base indicator element about the vertical axis, and after this can then be mounted again on the base indicator element by renewed implementation of the positive engagement.

The axial cohesion between the indicator elements axially inter-engaging via the toothed device is expediently provided by the already mentioned fastening screw, which passes through the two indicator elements. There is of course an alternative option for fastening the position indicator exclusively via the base indicator element on the indicator shaft and fixing the additional indicator element independently thereof on the base indicator element in a manner such that there is the possibility of the mentioned angle adjustment.

Preferably, the toothed device includes a ring gear formed in the region of the outer circumferential surface on the base indicator element and coaxial with the vertical axis, and a counter-toothing expediently formed on the free end section of the second leg section of the additional indicator element and complementary to the ring gear of the base indicator element. The complementary counter-toothing preferably has an arcuate longitudinal extension around the vertical axis of the position indicator.

It is advantageous if the position indicator not only produces a purely optical position indication visually detectable by a nearby observer, but is also additionally designed to generate electrical position signals that can thus be processed in an electronic control device. In this connection the base indicator element is preferably equipped with a plurality of actuating elements arranged distributed around the vertical axis, which belong to a position detection device serving for the detection of multiple rotational positions of the position indicator device. The actuating elements are preferably of the permanent magnet type and are inserted into the base indicator element, in particular from underneath. Conveniently, the base indicator element is equipped with two actuating elements, wherein the base indicator element can however have more than two insertion positions, on which the actuators can be selectively mounted. Alternatively, the position indicator can be equipped with only a single actuating element.

### BRIEF DESCRIPTION OF THE DRAWINGS

Aspects of the invention will be explained in more detail with the aid of the accompanying drawings, in which:

FIG. 1 is a perspective representation of a preferred embodiment of the process valve according to the invention, which is arranged with a preferred embodiment of the rotary drive according to the invention and which furthermore has an advantageous embodiment of the position indicator according to the invention,

FIG. 2 shows the rotary drive apparent in FIG. 1, equipped with a position indicator, in an exploded perspective individual representation,

FIG. 3 is an individual representation in an exploded perspective representation of the position indicator contained in the arrangement of FIGS. 1 and 2, in the state of the additional indicator element when lifted from the base indicator element,

FIG. 4 shows a bottom view of the position indicator from FIG. 3 looking in the direction of the arrow IV from FIG. 3,

FIG. 5 is a perspective bottom view of the position indicator, in which actuating elements used for a position detection are shown prior to the insertion into the base indicator element,

FIG. 6 is a perspective view of the position indicator, in which the additional indicator is positioned angularly to illustrate an I-valve-type symbol,

FIG. 7 shows the position indicator from FIG. 6 in a plan view, in which the illustrated valve-type symbol is additionally shown as a thickened line symbol for clarity,

FIG. 8 is a perspective view of the position indicator, in which the additional indicator is positioned angularly to illustrate an L-valve-type symbol,

FIG. 9 shows the position indicator from FIG. 8 in a plan view, in which the illustrated valve-type symbol is additionally shown as a thickened line symbol for clarity,

FIG. 10 is a perspective view of the position indicator, in which the additional indicator is positioned angularly to illustrate a T-valve-type symbol,

FIG. 11 shows the position indicator of FIG. 10 in a plan view, in which the illustrated valve-type symbol is additionally shown as a thickened line symbol for clarity.

### DETAILED DESCRIPTION

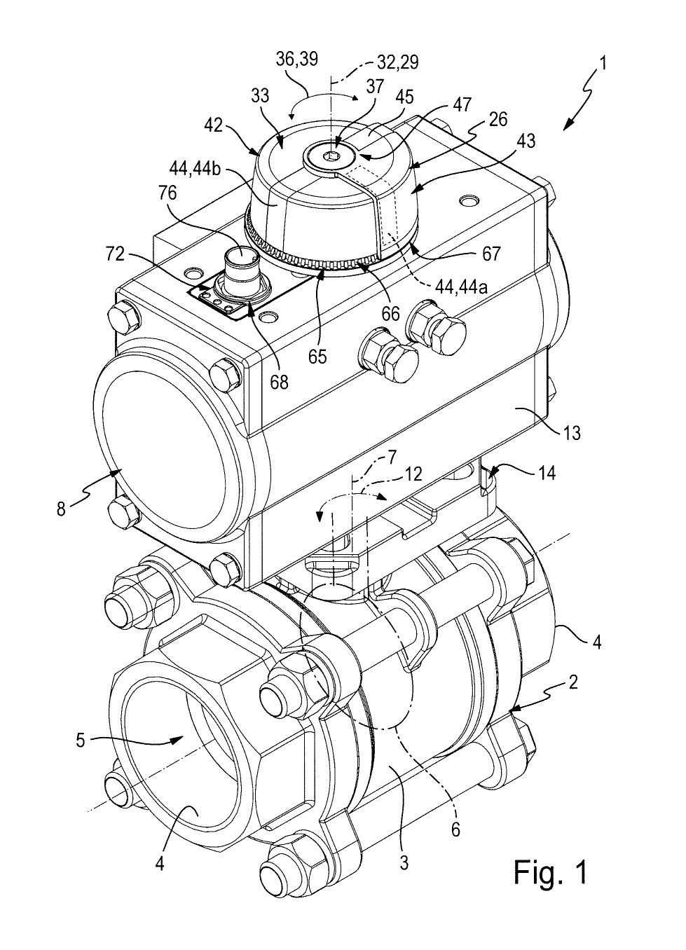

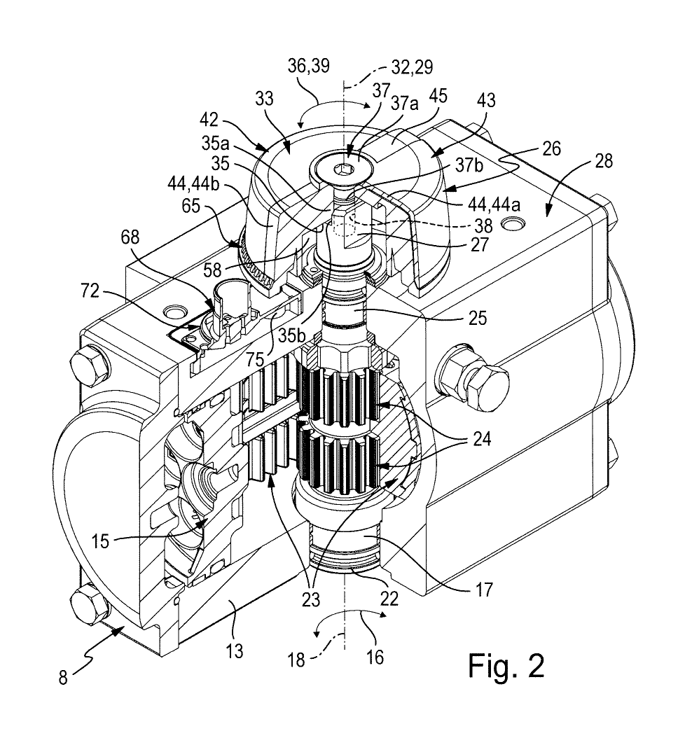

FIG. 1 illustrates a process valve 1, in which advantageous embodiments of the measures according to the invention are realized.

The process valve 1 contains a valve fitting 2 with a valve housing 3, which has a plurality of externally accessible valve connections 4, to which in each case an extension pipeline can be connected. A fluid channel structure 5 formed in the interior of the valve housing body 3 communicates with all valve connections 4 and allows the passage of a fluid process medium through the valve housing 3.

A valve member 6, indicated only schematically, is located in the interior of the valve housing 3, which can be positioned in various operating positions by rotation about a valve member rotation axis 7, in order to free or shut off the fluid connection between the individual valve connections 4 according to a valve-type-specific pattern within the fluid channel structure 5.

In the illustrated embodiment, the fluid channel structure 5 has a fluid channel passing substantially rectilinearly through the valve housing 3, which terminates in two oppositely facing valve connections 4. The valve member 6 can be positioned by turning it in two operating positions, in which it frees or shuts off the fluid connection between the two valve connections 4. On account of the rectilinear flow behaviour the process valve 1 represents an I-valve-type.

Depending on the number and distribution of the valve connections 4, the valve fitting 2 can also have a different functionality, which then results in other types of process valves. Thus, an L-valve-type can have more than two valve connections 4 arranged angularly with respect to one another, so that the fluid passage through the valve fitting 2 follows an L-shaped course, which means that one can speak of an L-valve-type. In a likewise advantageously possible T-valve-type of the process valve 1, the fluid channel structure 5 is designed so that the associated valve connections 4, in particular four pieces, are in case each connected together in a T-shaped flow pattern depending on the adjusted operating position of the valve member 6.

It is understood that, depending on the valve-type of the process valve 1, the associated valve member 6 is designed so that the described connection and isolation pattern between the various valve connections 4 can be predetermined.

The possible rotational movement of the valve member 6 about the valve member rotational axis 7 in order to specify the individual operating positions is referred to as adjusting movement 12 and is indicated in the drawing by a double arrow.

The process valve 1 furthermore has a rotary drive 8 serving to produce the adjusting movement 12 of the valve member 6. The rotary drive 8 is attached to the valve fitting 2. In particular the rotary drive 8 has a drive housing 13, which is fastened to the valve housing 3 via a suitable fastening interface 14.

The rotary drive 8 has drive means 15 arranged in the interior of the drive housing 13, by means of which a drive shaft 17 rotatably mounted in the drive housing 13 can be driven in a reciprocating drive movement in a direction indicated by a double arrow. The axis of rotation of the drive movement 16 coincides with the longitudinal axis 18 of the drive shaft 17.

The drive shaft 17 is accessible from outside the valve housing 3 at a lower side of the rotary drive 8 facing the valve fitting 2. The drive shaft 17 has there a coupling end portion 22, with which it is connected in a torque-proof manner to the valve member 6, so that the drive movement 16 of the drive shaft 17 directly results in the adjusting movement 12 of the valve member 6. The longitudinal axis 18 of the drive shaft 17 is aligned coaxially with the valve member rotation axis 7.

The rotary drive 8 of the embodiment is of a fluid-operated design and is actuated in particular with compressed air or another fluid pressure medium. In this connection the drive means 15 include in particular a rack and pinion arrangement 23 linearly reciprocally movable in the interior of the drive housing 13 by fluid force and a sprocket arrangement 24 arranged coaxially and in a torque-free manner on the drive shaft 17, and meshing with the rack and pinion arrangement 23. By means of a valve arrangement, not shown in further detail, the rack and pinion arrangement 23 can be driven to perform a reciprocating linear movement by controllable fluid impact on the rack and pinion arrangement 23, resulting in the rotatory drive movement on account of the existing toothing engagement with the ring gear 24 arrangement.

According to a non-illustrated embodiment, the rotary drive 8 may also be an electric or electromagnetic rotary drive.

By appropriate control of the rotary drive 8, the drive shaft 17 can be rotated and in this way the valve member 6 connected thereto in a torque-proof manner can be positioned in the desired operating position. Preferably the operational control of the rotary drive 8 is accomplished by an electronic control device, not illustrated further.

The rotary drive 8 has an indicator shaft 25 accessible from outside the valve housing 3, and which always rotates together with the drive shaft 17 about an axis of rotation 29 defined by its longitudinal axis. The indicator shaft 25 is preferably formed as a single-piece assembly with the drive shaft 17, but may also be a separate shaft coupled by suitable means on the drive side to the drive shaft 17.

The indicator shaft 25 is used to indicate the current rotational position of the drive shaft 17 and thus indirectly also the current operating position of the valve member 6 coupled in a torque-free manner to the drive shaft 17. Depending on the operating position of the valve member 6, the indicator shaft 15 adopts different relative rotational positions with respect to the valve housing 3. These are recognisable to a viewer, wherein in order to improve the visual perceptibility of the respective rotational position, the indicator shaft 25 is combined with a position indicator 26 located outside the drive housing 13.

The position indicator 26 is connected in a torque-free manner in the region of an outer side of the valve housing 3 oriented in the axial direction of the indicator shaft 25 to an end portion 27 of the indicator shaft 25 that is accessible there. The end portion 27 expediently protrudes from the valve housing 3. It is located in particular on an upper side 28 of the rotary drive 8 opposite the valve fitting 2.

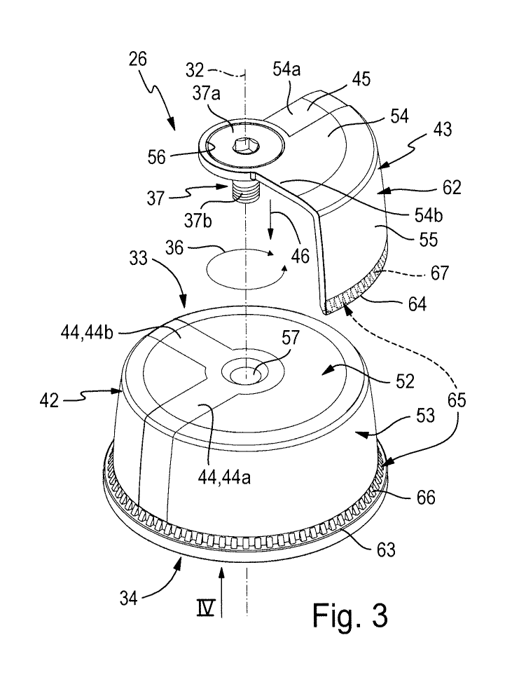

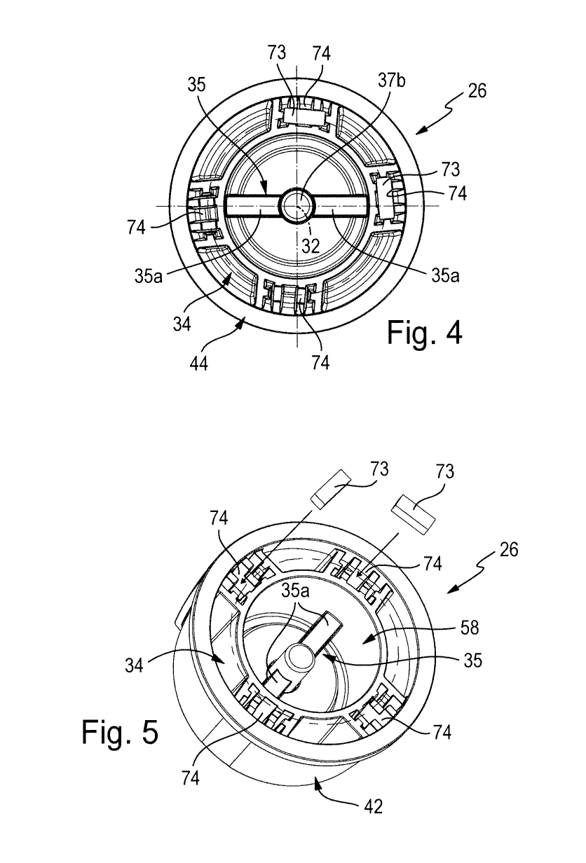

The position indicator 26, also shown again separately in FIGS. 3 to 11, has an imaginary central vertical axis 32 which coincides with the axis of rotation 29 of the indicator shaft 25, formed by way of example by the longitudinal axis 18, when the position indicator 26 is mounted on the end portion 27 of the indicator shaft 25 on adopting its position of use.

On turning the indicator shaft 25, the position indicator 26 performs a synchronous rotational movement 39 about the vertical axis 32.

The position indicator 26 has an upper side 33 oriented in the axial direction of the vertical axis 32 and an underneath side 34 axially opposite thereto. In the mounted position of use its underneath side 34 faces towards the rotary drive 8.

The position indicator 26 is designed for the releasable torque-proof plug-in connection with the end section 27 of the indicator shaft 25. For this purpose, it has on the underneath 34 a mounting interface 35 coaxial with the vertical axis 32, which can be axially plugged onto the end portion 27 in such a way that in the circumferential direction 36 of the vertical axis 32 indicated by a double arrow a positive type engagement is established, enabling a torque transmission between the position indicator 26 and the indicator shaft 25.

By way of example, the mounting interface 35 comprises a transverse web 35a extending radially with respect to the vertical axis 32, which engages in a carrier slit 35b having a complementary cross-sectional contour, which is introduced from the free front face into the end section 27 of the indicator shaft 25.

For the axially immovable fixing on the indicator shaft 25 the position indicator 26 expediently includes a fastening screw 37, which passes centrally axially through the position indicator 26, wherein ‘axially’ is understood to mean the axial direction of the vertical axis 32. The fastening screw 37 has a screw head 37a, by means of which it is supported on the upper side 33 of the position indicator 26, and also a position indicator 26 passing centrally through the threaded shaft 37b, which is screwed into a threaded bore 38 of the indicator shaft 25, open at the front on the end portion 37. By suitably tightening the fastening screw 37 the position indicator 26 is axially clamped in a releasable manner to the indicator shaft 25.

By unscrewing the fastening screw 37 from the threaded bore 38 the position indicator 26 can be removed at any time for any reason from the indicator shaft 25 and thus from the rotary drive 8 as a whole.

Instead of the fastening screw 37, in a non-illustrated embodiment, a fastening clip is provided. The fastening clip expediently has a head supported on the upper side 33 of the position indicator 26 and a shaft passing centrally through the position indicator 26 is provided for locking engagement with the indicator shaft 25. The mounting clip is locked to the indicator shaft 25, in particular in a releasable manner

The position indicator 26 is formed of several parts, and in particular of two parts. It comprises two indicator elements 42, 43 cooperating in a special way, which for the sake of better differentiation are referred to in one case as base indicator element 42 and in the other case as additional indicator element 43. They are components separated from another that can be assembled or are assembled to form one unit, namely the position indicator 26.

Each indicator element 42, 43 has at least one visually recognisable marking, which in the case of the base indicator element 42 is referred to as base indicator marking 44 and in the case of the additional indicator element 43 as additional indicator marking 45. The base indicator element 42 has multiple base indicator markings 44 that are distributed about the vertical axis 32 in the circumferential direction 36. Preferably the base indicator element 42 is provided with exactly two base indicator markings 44, which are expediently arranged angularly offset from one another by 90 degrees, which applies to the embodiment. The additional indicator element 43 has at least one additional indicator marking 45, wherein it is expediently provided with only a single additional indicator marking 45, which applies to the embodiment.

Preferably, each indicator marking 44, 45 is strip-shaped and is radially aligned with respect to the vertical axis 32. As a result the indicator marking 44, 45 is very clearly visible to an observer. Each indicator marking 44, 45 conveniently has a different colour and/or a different surface structure than the remaining component of the associated indicator element 42, 43, so that there is a colour and/or structural contrast, which promotes optical perceptibility.

Each indicator marking 44, 45 is preferably arranged facing at least partially axially upwards on the associated indicator element 42, 43, so that it is clearly visible when viewed from the upper side 33. Each indicator marking 44, 45 can however extend at least partially also in the outer circumferential region, facing radially outwardly with respect to the vertical axis 32, of the respective indicator element 42, 43. In the illustrated embodiment each indicator marking 44, 45 advantageously extends radially outwards starting from a region close to the centre on the upper side associated with the vertical axis 42, and then along the radially outer circumference of the relevant indicator element 42, 43 downwards in the direction of the underneath side 34. As a result the indicator markings 44, 45 can be recognised particularly well also obliquely from the side.

In the position of use of the position indicator 26, the additional indicator element 43 is attached externally to the base indicator element 42. The attachment is preferably effected with an attachment movement 46 illustrated by an arrow in the axial direction of the vertical axis 32 in the region of the upper side 33.

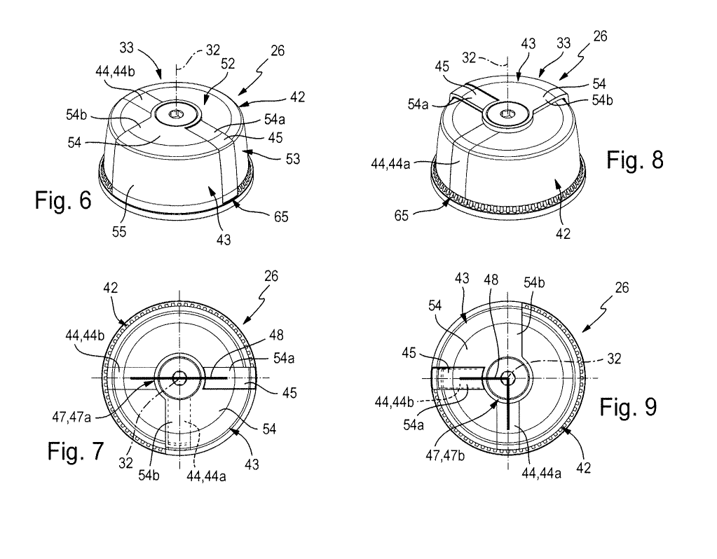

The position indicator 26 offers the advantageous possibility of positioning the additional indicator element 43 about the vertical axis 32 as centre in different rotational angular positions with respect to the base indicator element 42 and fixing it in a torque-proof manner in any angular position. In FIGS. 6 to 11 three positions of use of the position indicator 26 are shown, in which the additional indicator element 43 is fixed in different angular positions with respect to the base indicator element 42.

In each angular position of the additional indicator element 43 adjusted on the base indicator element, at least one base indicator marking 44 and the at least one additional indicator marking 45 are visible to the viewer. Due to the angular position in which the additional indicator element 43 is positioned on the base indicator element 42, it is possible to influence which of the base indicator markings 45 arranged on the base indicator element 42 are visible. In this connection there is the advantageous possibility of positioning the additional indicator element 43 in at least one angular position, which is referred to as cover angle position, because at least one base indicator marking 44 is covered by the additional indicator element 43 and at the same time at least one base indicator marking is uncovered and is therefore clearly visible to a viewer.

The respectively covered base indicator marking 44 is preferably completely invisible to a viewer. The desired effect can of course also be achieved even if the covered base indicator marking 44 is still visible to some extent, but appears visually in the background with respect to the other indicator markings 44, 45, for example if the additional indicator element 43 has a low light transmittance.

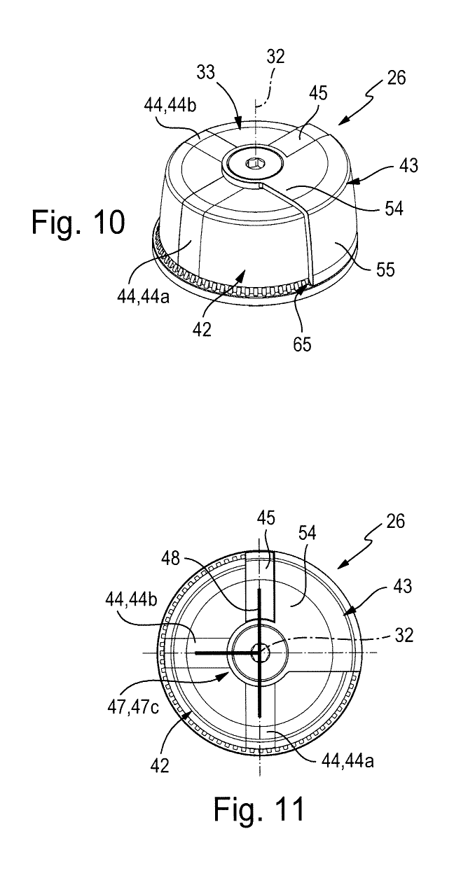

By way of example, the additional indicator element 43 can be positioned, inter alia, in an angular position evident from FIGS. 10 and 11, in which it does not cover any of the base indicator markings 44, so that from the outside each base indicator marking and each additional indicator marking 45 is visible.

FIGS. 6 and 7 on the one hand and FIGS. 8 and 9 on the other hand show the additional indicator element 43 in two different angle cover positions, which differ from one another in the rotational angle alignment with respect to the base indicator element 42. In a first cover angle position apparent from FIGS. 6 and 7, one of the two base indicator markings 44 is covered by the additional indicator element 43, which for a better differentiation is also termed first base indicator marking 44a. The other, second base indicator marking 44b is at the same time uncovered. In a second cover angle position visible in FIGS. 8 and 9, again only one of the existing base indicator markings 44 is covered by the additional indicator element 43, but in contrast to the first cover angle position the covered base indicator marking 44 is the second base indicator marking 44b, whereas the first base indicator marking 44a is uncovered.

Each multiple arrangement of indicator markings 44, 45 visible to the viewer represents a valve-type symbol 47 visually perceptible to a viewer, which is also additionally emphasised in the drawing as a line structure 48, because in practice colour and/or structure contrasts that are normally present in the drawings are not shown in the graphical depictions.

The valve-type symbols 47 that are for example adjusted are, according to FIGS. 6 and 7, an I-valve-type symbol 47a, in which an additional indicator marking 45 and a single, uncovered base indicator marking 44, 44b are linearly aligned. In an L-valve-type symbol adjusted according to FIGS. 8 and 9, the additional indicator marking 45 and two uncovered base indicator marking 44, 44a are arranged in an L-shape. In a T-valve-type symbol 47c adjusted in FIGS. 10 and 11 the additional indicator marking 45 and two uncovered base indicator markings 44, 44a, 44b are arranged in a T-shape.

During a rotational movement 39 of the position indicator 26 as a result of a rotary actuation of the indicator shaft 25 carrying it, the respectively associated valve-type symbol 47 is co-rotated, so that in each case it is directly recognisable what type of valve the associated process valve 1 is, and which operating position the valve member 6 of the relevant process valve adopts.

The mounting interface 35 already discussed further above is expediently formed on the underneath side 34 of the base indicator element 42. As an example, the transverse web 35a is interrupted, so that access to the threaded shaft 37b is possible.

The base indicator element 42 is expediently disc-shaped and has a circular outer contour when viewed in the axial direction of the main axis 32.

The base indicator 42 has a front surface 52 associated with the upper side 33 and an outer circumferential surface 53 facing radially outwards with respect to the main axis 32. While the outer circumferential surface 53 in the embodiment tapers slightly axially in the direction of the upper surface 52, it is formed circular cylindrically in an embodiment that is not illustrated.

The additional indicator element 43 is L-shaped and has two mutually angularly aligned first and second leg sections 54, 55. The angle enclosed by the two leg sections 54, 55 corresponds to the angle between the upper end face 52 and the outer circumferential surface 53, so that by way of example, on account of the tapering shape of the outer circumferential surface 53, it is a slightly obtuse angle.

The additional indicator element 43 is attached to the base indicator element 42 in such a way that it extends with the first leg section 54 along the upper end surface 52 in a radial direction with respect to the vertical axis 32 and with the second leg section 55 angled with respect thereto along the outer circumferential surface 53 in the axial direction towards the lower side 34. The second leg section 55 is suitably inclined corresponding to the tapering of the outer circumferential surface 43.

The additional indicator element 43 attached to the base indicator element 42 thus covers with its first leg section 54 a part of the upper end surface 52 and with its second leg section 55 a part of the circumferential extension of the outer circumferential surface 53.

The angular extension of the additional indicator element 43 in the circumferential direction 36 is selected depending on the valve-type symbols 47 to be visualised. It is particularly advantageous if the angular extent is 90 degrees, which is applicable to the embodiment.

According to the example, the first leg section 54 is formed in the shape of a circle sector with a central angle of at least substantially 90 degrees. The second leg section 55 adjoins the first leg section 54 in the region of the greatest circumferential extension and is expediently designed shell-shaped, in which connection it has at least substantially the same curvature in the circumferential direction 36 as the outer circumferential surface 53.

At the free end region opposite the second leg section 55 the first leg section 54 is penetrated by a fastening hole 56, whose centre also lies on the vertical axis 32, like the centre of another fastening hole 57, which is axially and centrally penetrated by the base indicator 42.

The two fastening holes 56, 57 are provided for the passage of the fastening screw 37, which is inserted through the two fastening holes 56, 57 when mounting the position indicator 26 on the indicator shaft 25 from the upper side 33. On tightening the fastening screw 37 the screw head 37a presses from above onto the first leg section 54 of the additional indicator element 43, which as a result is braced together with the base indicator element 42 incorporated axially therebetween with the end portion 27 of the indicator shaft 25.

The edge of the fastening hole 56 formed in the first leg section 54 is expediently shaped widening conically upwards, the screw head 37a tapering conically on the outer circumference, so that the additional indicator element 43 is centred with respect to this when it is fixed to the base indicator element 42.

The base indicator element 42 is preferably dish-shaped and has an interior 58 open towards the underneath side 34. The mounting interface 35 is expediently located in this interior. In the assembled position of use the indicator shaft 25 protrudes with its end portion 27 from below into the interior 58 of the base indicator element 42.

The preferably single additional indicator marking 45 of the additional indicator element 43 is expediently located in the region of one of the two side edges 54a, 54b of the sector-shaped first leg section 54 oriented in the circumferential direction 36 of the vertical axis 32. Preferably the additional indicator marking 45 is arranged on the outer surface 62 of the additional indicator element 43 facing away from the base indicator element 42.

In the illustrated embodiment each base indicator marking 45 extends radially outwards from the centre region of the upper end surface 52 with a first length along the upper end surface 52 and then with a second length along the outer circumferential surface 53 as far as the lower edge region 63 associated with the lower side 43. In a similar way the additional indicator markings 45 extends from a region adjacent to the vertical axis 32 on the outer surface 62 first of all radially outwards along the first leg section 54 and then along the second leg section 55 downwards to the lower edge region 64 of the second leg section 55. In the first cover angle position visible in FIGS. 6 and 7, the additional indicator marking 45 extends in the axial extension to the uncovered second base indicator marking 44b, which applies correspondingly to the associated first side edge 54a. The opposite second side edge 54b of the additional indicator element 43 in the circumferential direction 32 extends beyond the first base indicator marking 44a, so that this too is covered so as to be invisible from the outside.

In the second cover angle position visible in FIGS. 8 and 9, the additional indicator element 43 is attached to the base indicator element 42 in a torque-proof manner in such a way that the first side edge 54a comprising the additional indicator marking 45 covers the second base indicator marking 44b, whereas the first base indicator 44a is uncovered.

In the two cover angle positions one of the two base indicator markings 44a, 44b is therefore covered in each case by the additional indicator element 43, while the respective other base indicator marking 44b, 44a remains uncovered. The covering function is performed in the first cover angle position by the second side edge 54b free of markings, and in the second cover angle position by the first side edge 54a provided with the additional indicator marking 45.

For the torque-proof fixing of the additional indicator element 43 in the respectively adjusted angular position, in a non-illustrated embodiment exclusively the clamping force is used, with which the two indicator elements 42, 43 are clamped together by the fastening screw 37. In the advantageous illustrated embodiments the adjusted angular position is additionally fixed with a positive engagement effective in the circumferential direction 36.

A toothed device 65 is associated jointly with the two indicator elements 42, 43, by means of which the additional indicator element 43 is locked in a non-rotatable manner on the base indicator element 42 in the respectively adjusted angular position. By way of example the toothed device 65 contains a ring-shaped self-contained ring gear 66 formed on the base indicator element 42 coaxially to the vertical axis 32. The ring gear 66 is preferably located at the lower edge portion 63 on the radially outer side of the base indicator element 42. Conveniently the ring gear 66 delimits axially downwards the outer circumferential surface 53.

The toothed device 65 also includes a counter-toothing 67 complementary to the ring gear 66, which expediently has an arcuate longitudinal extension and expediently extends over the whole circumferential length of the second leg section 55. It is formed there in particular on the lower edge region 64, and in fact on the inside of the second leg section 55 facing the base indicator element 42.

During the axial attachment of the additional indicator element 43 to the base indicator element 42 according to the arrow 46, the counter-toothing 67 engages in the currently predetermined rotation angle position in the ring gear 66, so that the two indicator elements 42, 43 are supported in a non-rotatable manner on one another in the circumferential direction.

According to a non-illustrated embodiment, the counter-toothing 67 consists only of a single tooth projection, which engages in different recesses of the ring gear 66 depending on the rotational position of the additional indicator element 43.

While the inter-engaging components of the toothed device 65 are formed by way of example in the manner of the toothing of a toothed wheel and have a zigzag-shaped configuration, alternatively also other configurations may be provided that enable a positive engagement in the circumferential direction 36, for example on the one hand a plurality of successive holes spaced from one another and on the other hand at least one pin- or knob-shaped projection.

The ring gear 66 is expediently formed as a one-piece integral part of the base indicator element 42, which also applies accordingly to the counter-toothing 67 as regards the additional indicator element 43. Both indicator elements 42, 43 are preferably made of a plastic material.

If the angular position of the additional indicator element 43 is altered in order to change the illustrated valve-type symbol 47, this is done in such a way that first the fastening screw 37 is unscrewed and then the additional indicator element 43 is lifted from the base indicator element 42 by releasing the positive connection of the toothed device 65 against the arrow 46. In this lifted position the additional indicator element 43 is turned to the desired angular position and then, under renewed formation of the positive connection of the toothed device 65 again according to the arrow 46, is replaced on the base indicator element 42. Finally the fastening screw 37 is tightened again.

It is advantageous if the rotary drive 8 is additionally equipped with a position detection device 68, by means of which multiple rotational positions of the position indicator 26 can be detected in an electrically processable manner

The rotary drive 8 of the exemplary embodiment is equipped with such a position detection device 68, which has a sensor device 72 arranged on or in the drive housing 13 and a plurality of actuating elements 73 arranged on the position indicator 26 and suitable for activating the sensor device 72.

The actuating elements 73, which are preferably permanent magnets, are fixed to a plurality distributed around the vertical axis 32 on the base indicator element 42. For example, they are inserted into and in particular clipped onto receiving pockets 74 of the indicator element 42 open towards the underneath side 34. If only two rotational positions are to be detected, two actuating elements 73 are sufficient, wherein it is advantageous if the base indicating element 42 offers the possibility of installing more than two actuating elements 73.

With a corresponding configuration of the sensor device 72, a single actuating element 73 is already sufficient to detect a plurality of rotational positions of the position indicator 26. This is realised in a non-illustrated embodiment.

As an example, a total of four receiving pockets 74 are present, which are arranged at angular intervals of 90 degrees and which can be selectively equipped with an actuating element 73.

In the rotational movement of the position indicator 26 effected by the indicator shaft 25, the actuators 73 move along a circular path, in the region of which sensor means 75 of the sensor device are arranged on the drive housing 13, so that a contactless operation is possible when moving past the actuators 73, resulting in an electrical position signal that can be processed further. The sensor signals can be transmitted via an electromechanical interface 76 of the sensor device 72 to the already mentioned electronic control device.

What is claimed is:

1. A position indicator for a rotary drive of a process valve, which is designed for the torque-proof mounting on a rotatable indicator shaft of the rotary drive and has a vertical axis which in the mounted position of use of the position indicator coincides with the axis of rotation of the indicator shaft, the position indicator comprising a base indicator element having at least one base indicator marking and an additional indicator element having an additional indicator marking, wherein the additional indicator element can be positioned and fixed around the vertical axis as centre in different rotational angular positions with respect to the base indicator element, wherein the base indicator element has a plurality of base indicator markings arranged distributed around the vertical axis, wherein the additional indicator element can be positioned and fixed in at least one cover angle position with respect to the base indicator element, in which it covers at least one of the base indicator markings and in which at least one of the base indicator markings is uncovered, so that different visually perceptible valve-type symbols can be represented depending on the angular position adopted by the additional indicator, which in each case are composed of the additional indicator marking and the at least one uncovered base indicator marking.

2. A position indicator according to claim 1, wherein the base indicator element has two base indicator markings angularly offset by 90 degrees with respect to one another, wherein, depending on the angular position adopted by the additional indicator element, only one or neither of the two base indicator markings is covered.

3. A position indicator according to claim 1, wherein the additional indicator element can be positioned and fixed in three angular positions with respect to the base indicator element, in which the additional indicator marking together with at least one non-covered base indicator marking represents an I-shaped or L-shaped or T-shaped valve-type symbol.

4. A position indicator according to claim 1, wherein each indicator marking is formed strip-shaped in radial alignment with respect to the vertical axis.

5. A position indicator according to claim 1, wherein the base indicator element on a lower side has a mounting interface coaxial with the vertical axis for the torque-proof plug-in connection with an end section of the indicator shaft of the rotary drive.

6. A position indicator according to claim 5, further comprising a fastening screw, which in the mounted position of use of the position indicator passes through the two indicator elements under axial clamping in the axial direction of the vertical axis and is screwed to the indicator shaft.

7. A position indicator according to claim 1, wherein the base indicator element is disc-shaped with a circular outer contour, wherein it has an upper end surface which in the mounted position of use of the position indicator faces away from the associated rotary drive, and has a radially outwardly facing outer circumferential surface, wherein the additional indicator element is L-shaped and is attached to the base indicator element in such a way that it extends with a first leg section comprising at last partially the additional indicator marking in a radial direction with respect to the vertical axis along the upper end surface and with a second leg section angled downwardly with respect to the first leg section in the axial direction along the outer circumferential surface of the base indicator element.

8. A position indicator according to claim 7, wherein, the base indicator element is dish-shaped and is arranged with the open side facing downwards towards the rotary drive.

9. A position indicator according to claim 7, wherein the outer circumferential surface of the base indicator element tapers axially in the direction of the upper end face, wherein the second leg section of the additional indicator element is inclined correspondingly.

10. A position indicator according to claim 7, wherein the first leg section of the additional indicator element is formed in the shape of a circular sector.

11. A position indicator according to claim 10, wherein the first leg section of the additional indicator element is formed in the shape of a circular sector with a central angle of 90 degrees.

12. A position indicator according to claim 10, wherein the second leg section is formed shell-shaped with a curvature adapted to the outer circumferential surface of the base indicator element.

13. A position indicator according to claim 7, wherein the additional indicator marking is arranged in the region of one of the two side edges of the first leg section oriented in the circumferential direction of the vertical axis.

14. A position indicator according to claim 13, wherein the additional indicator marking is arranged on the outer surface of the first leg section facing away from the base indicator element.

15. A position indicator according to claim 7, wherein the first leg section on its free end region facing away from the second leg section is penetrated by a fastening hole provided for the passage of a fastening screw, which is aligned flush with a further fastening hole passing axially centrally through the base indicator element.

16. A position indicator according to claim 1, wherein a toothed device is associated jointly with the two indicator elements, by means of which the additional indicator element in the respective adjusted angular position is locked in a non-rotatable manner by positive engagement to the base indicator element.

17. A position indicator according to claim 16, wherein the additional indicator element can be lifted axially from the base indicator element in order to change its adopted angular position with respect to the base indicator element by cancelling the positive connection of the toothed device, can then be rotated with respect to the base indicator element, and after this, with renewed formation of the positive engagement of the toothed device, can be replaced on the base indicator element.

18. A position indicator according to claim 16, wherein the base indicator element is disc-shaped with a circular outer contour, wherein it has an upper end surface which in the mounted position of use of the position indicator faces away from the associated rotary drive, and has a radially outwardly facing outer circumferential surface, wherein the additional indicator element is L-shaped and is attached to the base indicator element in such a way that it extends with a first leg section comprising at last partially the additional indicator marking in a radial direction with respect to the vertical axis along the upper end surface and with a second leg section angled downwardly with respect to the first leg section in the axial direction along the outer circumferential surface of the base indicator element, and wherein the toothed device comprises a ring gear formed in the region of the outer circumferential surface on the base indicator element, coaxial to the vertical axis, and a counter-toothing formed on the second leg section, complementary to the ring gear.

19. A position indicator according to claim 18, wherein the counter-toothing is formed on the free end portion of the second leg section.

20. A position indicator according to claim 1, wherein the base indicator element is equipped with at least one actuating element, which is part of a position detection device for detecting multiple rotational positions of the position indicator.

21. A position indicator according to claim 20, wherein the at least one actuating element has permanent magnetic properties.

22. A position indicator according to claim 20, wherein the at least one actuating element is inserted from the underneath side into the base indicator element.

23. A position indicator according to claim 20, wherein the position detection device includes multiple actuating elements distributed around the vertical axis and arranged on the position indicator.

24. A rotary drive of a process valve, with a drive housing, in which drive means for generating a rotary drive movement of a drive shaft that can be coupled or is coupled to the rotatable valve member of a valve fitting are arranged, and on the outside of which the end section of a rotatable indicator shaft rotating together with the drive shaft is provided, on which is mounted in a torque-proof manner a position indicator participating in the rotational movement of the indicator shaft and having a vertical axis which coincides with the axis of rotation of the indicator shaft, wherein the position indicator further comprises a base indicator element having at least one base indicator marking and an additional indicator element having an additional indicator marking, wherein the additional indicator element can be positioned and fixed around the vertical axis as centre in different rotational angular positions with respect to the base indicator element, wherein the base indicator element has a plurality of base indicator markings arranged distributed around the vertical axis, wherein the additional indicator element can be positioned and fixed in at least one cover angle position with respect to the base indicator element, in which it covers at least one of the base indicator markings and in which at least one of the base indicator markings is uncovered, so that different visually perceptible valve-type symbols can be represented depending on the angular position adopted by the additional indicator, which in each case are composed of the additional indicator marking and the at least one uncovered base indicator marking.

25. A process valve, with a valve fitting and a rotary drive fixed to the valve fitting for rotationally driving a valve member of the valve fitting, wherein the rotary actuator has a rotatable indicator shaft on which a position indicator is mounted, wherein the position indicator has a vertical axis which coincides with the axis of rotation of the indicator shaft, the position indicator further comprising a base indicator element having at least one base indicator marking and an additional indicator element having an additional indicator marking, wherein the additional indicator element can be positioned and fixed around the vertical axis as centre in different rotational angular positions with respect to the base indicator element, wherein the base indicator element has a plurality of base indicator markings arranged distributed around the vertical axis, wherein the additional indicator element can be positioned and fixed in at least one cover angle position with respect to the base indicator element, in which it covers at least one of the base indicator markings and in which at least one of the base indicator markings is uncovered, so that different visually perceptible valve-type symbols can be represented depending on the angular position adopted by the additional indicator, which in each case are composed of the additional indicator marking and the at least one uncovered base indicator marking.

26. A process valve, with a valve fitting and a rotary drive fixed to the valve fitting for rotationally driving a rotatable valve member of the valve fitting, wherein the rotary actuator has a rotatable indicator shaft on which a position indicator is mounted, wherein the rotary drive further has a drive housing, in which drive means are arranged for generating a rotary drive movement of a drive shaft that is coupled to the rotatable valve member, and on the outside of which the end section of a rotatable indicator shaft rotating together with the drive shaft is provided, on which is mounted in a torque-proof manner a position indicator participating in the rotational movement of the indicator shaft and having a vertical axis which coincides with the axis of rotation of the indicator shaft, wherein the position indicator further comprises a base indicator element having at least one base indicator marking and an additional indicator element having an additional indicator marking, wherein the additional indicator element can be positioned and fixed around the vertical axis as centre in different rotational angular positions with respect to the base indicator element, wherein the base indicator element has a plurality of base indicator markings arranged distributed around the vertical axis, wherein the additional indicator element can be positioned and fixed in at least one cover angle position with respect to the base indicator element, in which it covers at least one of the base indicator markings and in which at least one of the base indicator markings is uncovered, so that different visually perceptible valve-type symbols can be represented depending on the angular position adopted by the additional indicator, which in each case are composed of the additional indicator marking and the at least one uncovered base indicator marking.
